(19) United States
(12) Patent Application Publication
(10) Pub. No.: US 2010/0158052 A1
(43) Pub. Date: Jun. 24, 2010

(54) ELECTRONIC DEVICE AND METHOD FOR SYNCHRONIZING A COMMUNICATION

(75) Inventors: Daniel Timmermans, Eindhoven (NL); Cornelis Hermanus Van Berkel, Eindhoven (NL); Adrianus Josephus Bink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/376,303

(22) PCT Filed: Aug. 6, 2007
(86) PCT No.: PCT/IB07/53086

§ 371 Date: Feb. 4, 2009

(30) Foreign Application Priority Data
Aug. 8, 2006 (EP) 06118569.0

(51) Int. Cl. H04J 3/06

(52) U.S. Cl. 370/503

(57) ABSTRACT

An electronic device is provided which comprises a plurality of processing units (IP1-IP6) and a flit-synchronous network-based interconnect (N) for coupling the processing units (IP1-IP6). The network-based interconnect (N) comprises at least one first and at least one second link. The at least one second link comprises N pipeline stages. The communication via the at least one second link and the N pipeline stages constitutes a word-asynchronous communication.

### FIELD OF THE INVENTION

The invention relates to an electronic device and a method for synchronizing a communication.

### BACKGROUND OF THE INVENTION

Novel system on chips use a growing number of modules like microprocessors, peripherals and memories which need to communicate with each other. Among these architectures with a multi-hop interconnect, networks on chip NOC proved to be scalable interconnect infrastructures, composed of routers (or switches) and network interfaces (NI, or adapters), on one or more dies (“system in a package”) or chips. However, only a few of the proposed architectures offer guaranteed services (or quality of service, QoS), such as guaranteed throughput, latency, or jitter.

One example of such an architecture is the AEthereal architecture with contentionfree routing or distributed TDMA as described by E. Rijpkema, K. Goossens, and P. Wielage, “A router architecture for networks on silicon”, In Proceedings of Progress 2001, 2nd Workshop on Embedded Systems, Veldhoven, the Netherlands, October 2001. Within the AEthereal network, a flit (flow control unit) is defined as a sequence with a fixed number of words which serve as a basic unit for communication. The routers and network interfaces of the network transmit their flits synchronously on all of their links, in other words with the same frequency and with a constant phase difference. If less words than possible are to be communicated within a flit, the additional words are marked empty. On the other hand if more words are to be communicated than fitting into a flit, several flits are constructed and communicated. A further example of a network on chip architecture is the Nostrum architecture with hot-potato routing with containers as shown by M. Millberg, E. Nilsson, R. Thid, and A. Jantsch, “Guaranteed bandwidth using looped containers in temporally disjoint networks within the Nostrum network on chip”, In Proc. Design, Automation and Test in Europe Conference and Exhibition (DATE), 2004.

However, these networks on chip NOCs require a global notion of synchronicity to avoid the contention of packets in the network on chip NOC by scheduling packet injection. Typically, these networks on chip have been implemented in a synchronous manner (i.e. with one global clock, either 100% synchronously or mesochronously).

Many other networks on chip NOCs have been reported without time-related (throughput, latency, jitter) Quality of Service QoS. Therefore, these do not require a global notion of synchronicity, such that their implementation may be synchronously or asynchronously.

### SUMMARY OF THE INVENTION

It is therefore an object of the invention to provide an electronic device with a network-based interconnect as well as a method for synchronizing a communication in an electronic device.

The invention provides an electronic device according to claim 1, a system on chip according to claim 7, and a method for synchronizing a communication according to claim 8. The dependent claims define advantageous embodiments.

Therefore, an electronic device is provided which comprises a plurality of processing units and a flit-synchronous network-based interconnect for coupling the processing units. The network-based interconnect comprises at least one first and at least one second link. The at least one second link comprises N pipeline stages. The communication via the at least one second link and the N pipeline stages constitutes a word-asynchronous communication.

Therefore, a flit synchronous network is provided with asynchronous pipelines for a transmission of flits through a long link within a network. Such a combination leads to a significant performance boost in terms of flit latency and throughput on the links, in particular if long links are included.

According to an aspect of the invention, a global flit clock is provided for generating a global flit clock signal for indicating the transmission of successive flits over the first or second link.

According to a further aspect of the invention, the communication over the at least one second link is performed using an asynchronous synchronization protocol.

According to still a further aspect of the invention, successive flits are transmitted via a link before the boundaries of a flit are reached.

Furthermore, a number of flits can be changed together. A chain of more K successive flits is transmitted during K successive flit slots.

The invention also relates to a system on chip which comprises a plurality of processing units and a flit-synchronous network-based interconnect for coupling the processing units. The network-based interconnect comprises at least one first and at least one second link. The at least one second link comprises N pipeline stages. The communication via the at least one second link and the N pipeline stages constitute a word-asynchronous communication.

The invention also relates to a method for synchronizing a communication within an electronic device and/or a system on chip having a plurality of processing units and a flit-synchronous network-based interconnect for coupling the processing units. The network-based interconnect comprises at least one first and at least one second link. The communication via the at least one second link is based on a word-asynchronous communication wherein the at least one second link comprises N pipeline stages.

The invention relates to the idea to combine a flit-synchronous network on chip with a partially asynchronous implementation. Network elements like the routers and network interfaces synchronize a communication on a single link based on an asynchronous protocol while the communication on all of its links is based on a predefined protocol, i.e. a flit-synchronous protocol. The communication via long links is performed based on asynchronous pipelines with a distinction between word and flit synchronization. In other words, the communication of words via a single link is performed based on an asynchronous protocol while the communication of flits is performed based on a predefined protocol. The provision of word asynchronous links is advantageous if the number of pipeline stages increases. Therefore, the principles of the present invention are advantageous in particular for complex systems comprising a great number of modules.

These and other aspects of the invention will be apparent from and elucidated with reference to the embodiments described hereinafter.

### BRIEF DESCRIPTION OF THE DRAWINGS

FIG. 1 shows a block diagram of an embodiment of a system on chip with a network on chip according to the invention,

FIG. 2 shows a block diagram of part of the system on chip of FIG. 1 according to a first embodiment,

FIG. 3 shows a part of the system on chip of FIG. 1 according to a second embodiment,

FIG. 4 shows a block diagram of part of a system on chip of FIG. 1 according to a third embodiment, and

FIG. 5 shows a graph for illustrating the performance of an embodiment of a system on chip according to the invention.

### DETAILED DESCRIPTION OF EMBODIMENTS

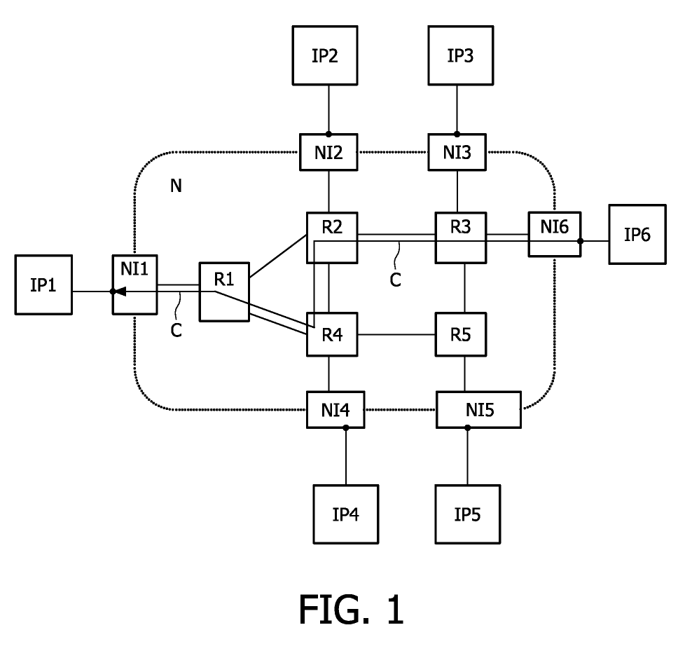

FIG. 1 shows a basic structure of an embodiment of a system on chip (or an electronic device) with a network on chip interconnect according to the invention. A plurality of IP blocks IP1-IP6 are coupled to each other via a network on chip N. The network N comprises network interfaces NI for providing an interface between the IP block IP and the network on chip N. The network on chip N furthermore comprises a plurality of routers R1-R5. The network interface NI1-NI6 serves to translate the information from the IP block to a protocol, which can be handled by the network on chip N and vice versa. The routers R serve to transport the data from one network interface NI to another. The communication between the network interfaces NI will not only depend on the number of routers R in between them, but also on the topology of the routers R. The routers R may be fully connected, connected in a 2D mesh, connected in a linear array, connected in a torus, connected in a folded torus, connected in a binary tree, in a fat-tree fashion, in a custom or irregular topology. The IP block IP can be implemented as modules on chip with a specific or dedicated function such as CPU, memory, digital signal processors or the like. Furthermore, a user connection C or a user communication path with a bandwidth of e.g. 100 MB/s between network interfaces NI6 and NI1 serving for the communication of IP6 with IP1 is shown.

The information from the IP block IP that is transferred via the network on chip N will be translated at the network interface NI into packets with potential variable length. The information from the IP block IP will typically comprise a command followed by an address and an actual data to be transported over the network. The network interface NI will divide the information from the IP block IP into pieces called packets and will add a packet header to each of the packets. Such a packet header comprises extra information that allows the transmission of the data over the network (e.g. destination address or routing path, and flow control information). Accordingly, each packet is divided into flits (flow control digit), which can travel through the network on chip. The flit can be seen as the smallest granularity at which control is taken place. An end-to-end flow control may be necessary to ensure that data is not sent unless there is sufficient space available in the destination buffer.

The communication between the IP blocks can be based on a connection or it can be based on a connection-less communication (i.e. a non-broadcast communication, e.g. a multi-layer bus, an AXI bus, an AHB bus, a switch-based bus, a multi-chip interconnect, or multi-chip hop interconnects). The network may in fact be a collection (hierarchically arranged or otherwise) of sub-networks or sub-interconnect structures, may span over multiple dies (e.g. in a system in package) or over multiple chips (including multiple ASICs, ASSPs, and FPGAs).

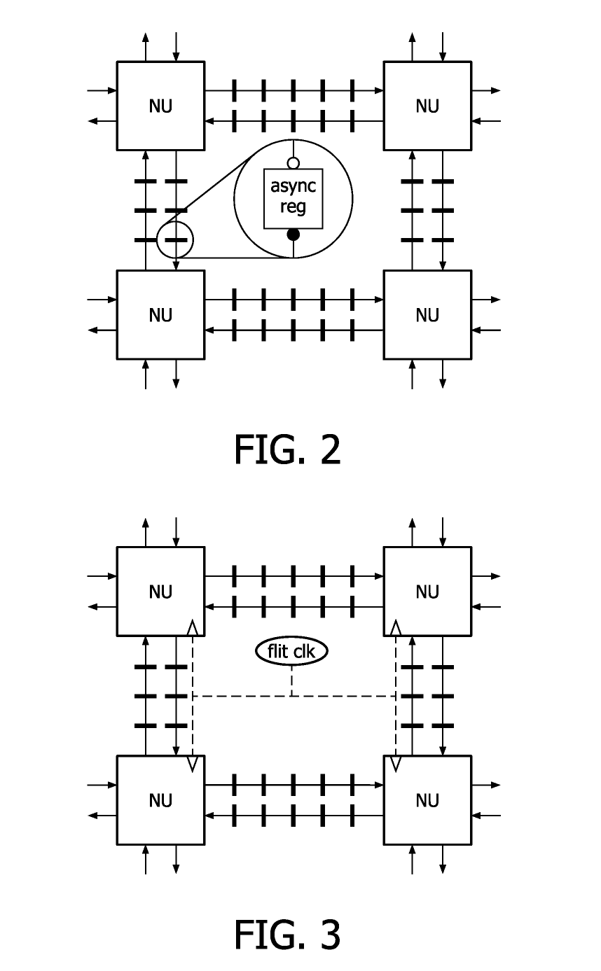

FIG. 2 shows a block diagram of part of the system on chip according to FIG. 1 according to a first embodiment. Here, four network units NU like routers or network interfaces are shown within the network which is preferably a flit-synchronous network. The network units NU are coupled by several links. Some of these links are asynchronously pipelined. The pipelined nature of the links is depicted by the bars.

The routers or network interfaces synchronize their communication of words on every link based on an asynchronous protocol. The synchronization of words on the link is advantageous with respect to a robust data transfer. On the other hand, the communication of the flits is performed synchronously, i.e. a flit-synchronization.

FIG. 3 shows a block diagram of part of a system on chip of FIG. 1 according to a second embodiment. Here, also four network units NU like routers or network interfaces are depicted which are coupled via links. In addition to the arrangement according to FIG. 2, a global flit clock signal is provided. The global flit clock signal serves to indicate when subsequent flits are to be transmitted over the links of the network. By using a global flit clock instead of a global word clock, the frequency of the clock can be reduced for cases where the flit size is at least two words.

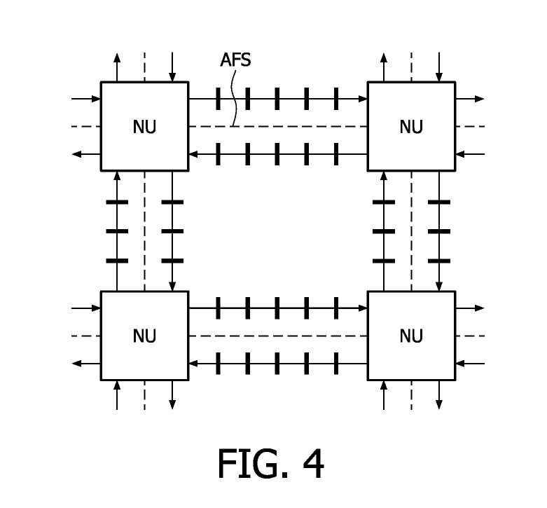

FIG. 4 shows a block diagram of part of a system on chip of FIG. 1 according to a third embodiment. The basic arrangement of the part of the system on chip according to the third embodiment substantially corresponds to the arrangement of the system on chip according to the first or second embodiment. In addition, a separate asynchronous flit synchronization AFS is provided for synchronizing the network units with their corresponding neighbors. This is preferably performed by using a synchronization handshake on a dedicated neighboring handshake channel by means of a so-called Muller C-element. Therefore, there is no need for a global flit clock as the global flit synchronization is established in a distributed and asynchronous manner.

In addition, optionally information regarding the number of non-empty words in a subsequent flit can be decoded into the flit handshake. Therefore, less power may be consumed in the link if there is no actual data to be transmitted.

According to a further embodiment of the present invention which is based on the first, second or third embodiment, the boundaries of a flit can be discarded on a local and/or temporarily basis. By discarding the boundaries of the flits, the transmission of successive flits on a link can be allowed before the global beginning of successive flits in the network. In addition, the flits may be chained together. Therefore, the several flits can be considered as a single flit with a flit size being higher than the first flits. Therefore, the link latency for the initial word within a successive flit can be avoided.

The latency of a chain within a link can be defined as follows:

LT_{link,chain}=N·LT_{stage,word}+(k·flitsize−1)·CT_{stage,word}=(N·c+k·flitsize−1)·CT_{stage,word},

where k is the number of flits in the chain, LT_{link,chain} is the latency of the chain, LT_{stage,word} is the latency of words in the stage.

In other words, instead of transmitting a chain of flits faster than based on a global flit-synchronicity, a chain of more than K successive flits can be transmitted during K successive flit slots. Accordingly, the throughput of the link is temporarily boosted in such a case.

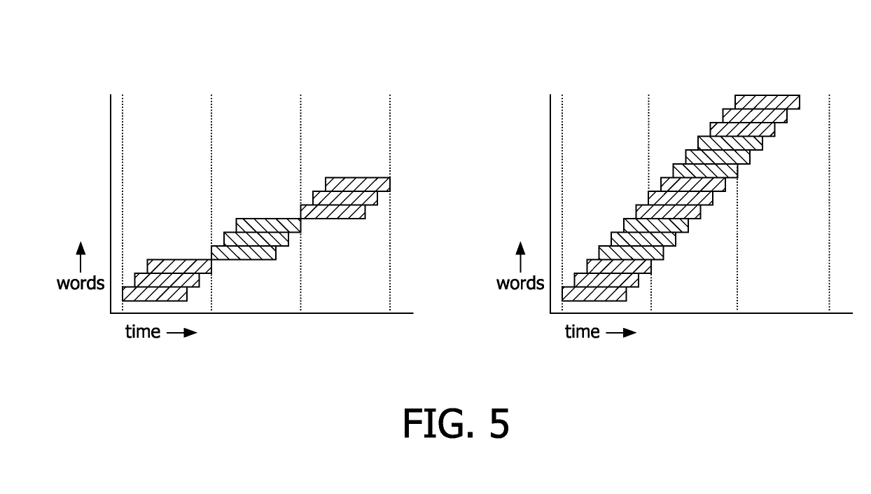

FIG. 5 shows a graph of the representation of the performance of an embodiment of a system on chip according to the invention. On the left hand side, the number of flits being communicated via a link are aligned on flit-synchronous boundaries depicted as the dash lines. On the right hand side, five successive flits are chained together such that any intermediate flit-synchronous boundaries are discarded.

In other words, the throughput of flits on a pipelined link can be improved by implementing a pipelined link asynchronously within a flit-synchronous network. If the link comprises N pipeline stages, the latency LT and the cycle time CT will result in the following latency:

LT_{stage,word}=c·CT_{stage,word}, where c=1 for synchronous pipelines and 0<c<1 for asynchronous pipelines.

The latency of a flit transversing this link will correspond to the latency of the first word within the flit plus the cycle time of a stage for each successive word within a flit. In other words, the latency of a flit transversing link corresponds to the latency of the first word transversing link and the cycle times of a stage of the remaining words. Therefore, the latency of a flit within a link will correspond to

LT_{link,flit}=N·LT_{stage,word}+(flitsize−1)·CT_{stage,word}=(N·c+flitsize−1)·CT_{stage,word}

If as an example a link comprises four pipeline stages and the size of the transfer flits is three, and furthermore if the synchronous pipeline stage has a cycle time of 0.8 ns, the latency of the flit over the link will correspond to the latency LT_{link,flit}=(4·1+3−1)·0.8 ns=4.8 ns. Accordingly, a maximum flit clock frequency will correspond to LT_{link, flit}⁻¹=2.1·10⁸ flits/s. However, as an example, if the asynchronous pipeline stage comprises a cycle time of 0.8 ns and the latency will correspond to 0.25 ns, the latency of the flit over the link will correspond to LT_{link,flit}=(4·0.25/0.8+3−1)·0.8 ns=2.6 ns. Therefore, a maximum flit clock frequency of LT_{link,flit}−1=3.8·10₈ flits/s is achieved. In other words, a performance boost of 85% is reached.

In addition, relying on a flit synchronicity while discarding a word synchronicity a flit clock signal may comprise a lower frequency if the flit size is at least two. According to the principles of the invention, the clock signal will allow a lower power consumption and a less stringent clock distribution. The dynamic power consumption on a link is zero when there is no flit to be transmitted as a word communication over links is not used for indicating the flit progress. In addition, a point-to-point link synchronization that is faster and cheaper is achieved when the communication of words is synchronized on all links.

The above-described principles of the invention can be applied to a system on chip comprising a flit-synchronous network on chip. One example of such a network is the AEthereal network on chip. The above-described principles of the invention are in particular advantageous if the word-asynchronous link grows as the number of pipeline stages in the link increases.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single . . . or other unit may fulfill the functions of several items recited in the claims. The mere fact that certain measures are recited in mutually different dependent claims does not indicate that a combination of these measured cannot be used to advantage.

Any reference signs in the claims should not be construed as limiting the scope.

1. Electronic device, comprising:
a plurality of processing units (IP1-IP6),
a flit-synchronous network-based interconnect (N) for coupling the processing units (IP1-IP6),
wherein the network-based interconnect (N) comprises at least one first and at least one second link,
wherein the at least one second link comprises N pipeline stages, wherein the communication via the at least one second link is a word-asynchronous communication.

2. Electronic device according to claim 1, furthermore comprising:
a global flit clock (flit clk) for generating a global flit clock signal for indicating the transmission of successive flits over the first or second link of the network-based interconnect.

3. Electronic device according to claim 1, wherein the communication over the at least one second link is performed using asynchronous synchronization protocols.

4. Electronic device according to claim 3, wherein successive flits are transmitted via a link before boundaries of a flit are reached.

5. Electronic device according to claim 4, wherein a number of flits are chained together.

6. Electronic device according to claim 5, wherein a chain of more than K successive flits are transmitted during K successive flit slots.

7. System on chip, comprising:
a plurality of processing units (IP1-IP6),
a flit-synchronous network-based interconnect (N) for coupling the processing units (IP1-IP6),
wherein the network-based interconnect (N) comprises at least one first and at least one second link,
wherein the at least one second link comprises N pipeline stages, wherein the communication via the at least one second link is a word-asynchronous communication.

8. Method for synchronizing a communication within an electronic device and/or a system on chip having a plurality of processing units and a flit-synchronous network based interconnect for coupling the processing units, wherein the network-based interconnect comprises at least one first and at least one second link, comprising the steps of:
communicating via the at least one second link based on a word-asynchronous communication, wherein the at least one second link comprises N pipeline stages.
